(19) United States
(12) Patent Application Publication
(10) Pub. No.: US 2001/0024177 A1
(43) Pub. Date: Sep. 27, 2001

(54) Holographic display system

(76) Inventor: Milan M. Popovich, Leicester (GB)

Correspondence Address: RITTER VAN PELT & YI, L.L.P., 4906 EL CAMINO REAL, SUITE 205, LOS ALTOS, CA, 94022

(21) Appl. No.: 09/733,233

(22) Filed: Dec. 7, 2000

Related U.S. Application Data
(60) Provisional application No. 60/169,834, filed on Dec. 7, 1999.

(51) Int. Cl. G09G 5/00

(52) U.S. Cl. 345/8

(57) ABSTRACT

A display system comprising a display device operable to display an image, a first optical device positioned to receive light from the image displayed on the display device and reflect the light, and a second optical device positioned to receive light reflected by the first optical device and reflect the light back towards the first optical device. The first optical device comprises at least one holographic diffraction element positioned such that light received from the display device is received at an angle that satisfies the Bragg diffraction condition and is reflected by the first optical device and light received from the second optical device is received at an angle that does not satisfy the Bragg diffraction condition and is transmitted through the first optical device.

### RELATED APPLICATIONS

The present application claims the benefit of U.S. Provisional Application Ser. No. 60/169,834 filed Dec. 7, 1999.

### BACKGROUND OF THE INVENTION

The present invention relates generally to image generating devices, and more particularly, to compact display systems, such as those used in head mounted displays.

Head mounted displays have received considerable attention as a technique for displaying high magnification, large field of view, and high definition virtual images. The head mounted display generally includes a support member for mounting the display on a head of a user and various optical and display components. The components are arranged to magnify an image displayed on a compact image display panel (microdisplay) such as a liquid crystal display (LCD) and to display the magnified image to the user.

When a multi-color display is required, a sequence of images is often displayed and illuminated sequentially with red, green, and blue lights. The switching from one image to the next is performed rapidly (e.g., at a rate faster than the response time of a human eye) so that a color image is created in the viewer's eye due to the integration of red, green, and blue monochrome images. This allows a viewer to see a full color image generated from a display system having a display screen operable to produce only monochrome images. In order to provide a full color magnified image for the user of the display system, the magnifying optics must be configured to provide the maximum required field of view and exit pupil, while minimizing monochromatic aberrations, such as spherical aberration, coma, astigmatism and chromatic aberrations. Attempting to satisfy these requirements with conventional optical elements such as lenses and mirrors typically adds weight and complexity to the display system. This is a particular problem in head mounted displays where the optical design often results in large and heavy optical elements in from of the eyes. Conventional diffractive optical elements (including thin and Bragg holographic optical elements and general diffractive elements based on surface relief structure for example) are capable of reducing the number of elements and compressing the size and form factor of the display. However, conventional diffractive optical elements have very large chromatic aberrations which make them difficult to incorporate in most head-mounted display optical designs.

Furthermore, head mounted displays are typically configured to view an image displayed by the display device and does not easily permit the user to view images from his surroundings. These display systems typically do not permit the image displayed on the display device to be combined with images from the user's surroundings.

### SUMMARY OF THE INVENTION

A display system of the present invention generally comprises a display device operable to display an image, a first optical device positioned to receive light from the image displayed on the display device and reflect the light, and a second optical device positioned to receive light reflected by the first optical device and reflect the light back towards the first optical device. The first optical device comprises at least one holographic diffraction element and is positioned such that light received from the display device is received at an angle that satisfies the Bragg diffraction condition and is reflected by the first optical device and light received from the second optical device is received at an angle that does not satisfy the Bragg diffraction condition and is transmitted through the fist optical device.

The above is a brief description of some deficiencies in the prior art and advantages of the present invention. Other features, advantages, and embodiments of the invention will be apparent to those skilled in the art from the following description, drawings, and claims.

### BRIEF DESCRIPTION OF THE DRAWINGS

FIG. 1 is schematic of a display system of the present invention.

FIG. 2 is a perspective view of a holographic optical element of the display system of FIG. 1.

FIG. 3 is a partial front view of the holographic optical element of FIG. 2 illustrating an electrode and electric circuit of the holographic optical element.

FIG. 4 is a schematic of three holographic optical elements each optimized to diffract red, green, or blue light, and an electronic controller operable to switch each of the elements between their active and passive states.

FIG. 5 is a diagram illustrating the Bragg Condition.

Corresponding reference characters indicate corresponding parts throughout the several views of the drawings.

### DETAILED DESCRIPTION OF THE INVENTION

The following description is presented to enable one of ordinary skill in the art to make and use the invention. Descriptions of specific embodiments and applications are provided only as examples and various modifications will be readily apparent to those skilled in the art. The general principles described herein may be applied to other embodiments and applications without departing from the scope of the invention. Thus, the present invention is not to be limited to the embodiments shown, but is to be accorded the widest scope consistent with the principles and features described herein. For purpose of clarity, details relating to technical material that is known in the technical fields related to the invention have not been described in detail.

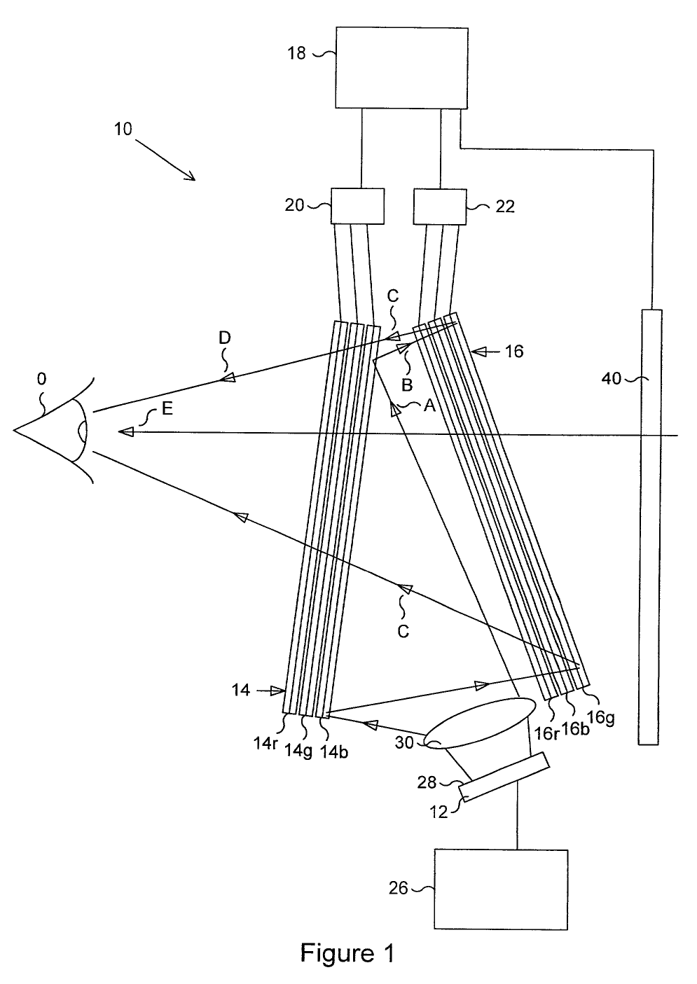

Referring now to the drawings, and first to FIG. 1, a display system of the present invention is shown and generally indicated at 10. The system 10 may be used in a head mounted display, handheld display, display for a digital camera or other compact display system. The system 10 includes a display device 12 operable to produce an image, a first holographic optical device, generally indicated at 14, a second holographic optical device, generally indicated at 16, a main controller 18, and two driver controllers 20, 22. A driver circuit 26 is coupled to the display device 12 for controlling the image displayed on a surface 28 of the display device. Relay optics 30 are provided to relay light from the display surface 28 to the first optical device 14 which is positioned to reflect this light towards the second optical device 16. The second optical device 16 reflects the light back to the first optical device 14 which transmits the light therethrough toward an observer's eye 0. As further described below, the display system 10 may include a shutter 40 which is operable to block surrounding light from the observer's eye 0 when the display system is used to view an image displayed by the display device.

The display 12 generates video or graphic information and may comprise a liquid crystal display (LCD) panel, or any other spatial light modulator (SLM) which reflects or transmits light produced externally. The display may be a front-illuminated reflective display or a rear-illuminated transmissive display. The display 12 may be a miniature reflective LCD having either a nematic or ferroelectric material on a silicon backplane, for example. The display 12 may also be based on transmissive display technologies. The display may have colored pixels (e.g., red, green, and blue) so that it produces a full color image when illuminated by white light. Alternatively, the display may be emissive and employ a matrix of red, green, and blue LEDs or an electroluminescent display. The image inputted to the display device 12 by the driver circuit 26 may be a normal image, or can be pre-distorted to compensate for distortions occurring due to the holographic optical devices 14, 16.

The display device 12 may be a color sequential display in which monochrome images are displayed in sequence. For example, the display 12 may be color illuminated sequentially using separate red, green, and blue light sources so that images projected from the display appear to be displayed as a composite multicolor image. Switching between the different colors is performed very rapidly so that the red, green, and blue image components are transmitted to the observer in quick succession. These components are combined over eye integration time so that the observer perceives what is effectively a full color image. Operation of the display device 12 is synchronized with the optical devices 14, 16 so that red elements of the optical devices are activated when the device displays the red component of the final image, blue elements are activated when the blue image is displayed, and green elements are activated when the green image is displayed.

A micro-electromechanical system, such as a Digital Light Processor (DLP) using a Digital Micromirror Device™ (DMD) available from Texas Instruments, may be used as the display 12. The DMD is a micromechanical silicon chip having movable mirrors which reflect light to create high quality images. An image is formed on the reflective surface of the DMD by turning the mirrors on or off digitally at a high speed. An image is generated by color sequentially illuminating the display and turning individual mirrors on or off for durations which depend on the amount of each primary color required to generate the required color value at each pixel.

The display 12 may also be a diffractive display device such as a Grating Light Valve™ (GLV) available from Silicon Light Machines (formerly Echelle, Inc.). The GLV uses micro-electromechanical systems to vary how light is reflected from multiple ribbon structures which can move small distances to create a grating that selectively diffracts specified wavelengths of light. Picture elements (pixels) are formed on the surface of a silicon chip and become the image source for display projection. It is to be understood that display panels other than those described herein may be used without departing from the scope of the invention.

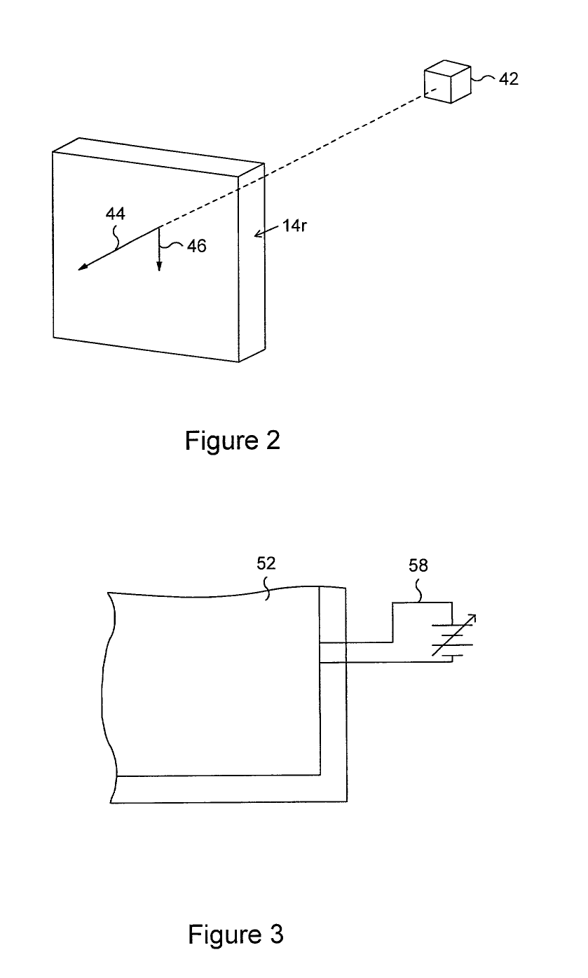

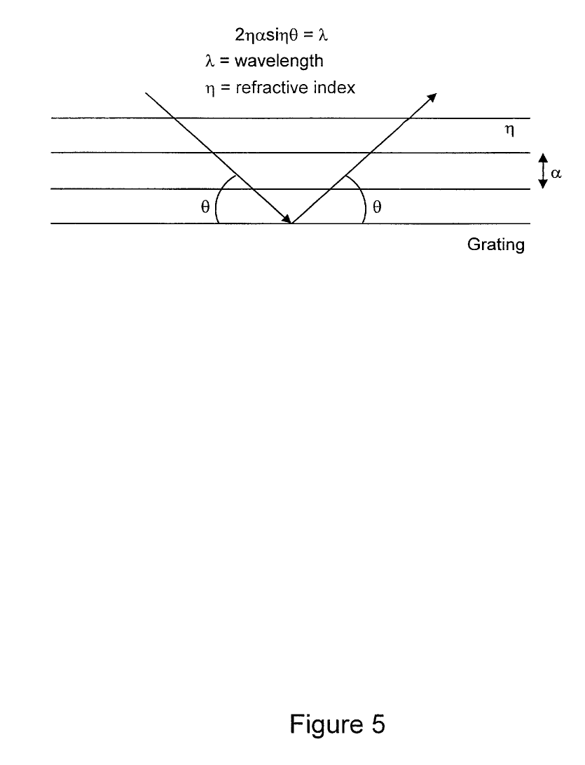

The holographic optical devices 14, 16 each include three switchable holographic elements (14r, 14g, 14b), (16r, 16g, 16b) that each act upon red, green, or blue light, respectively. The holographic optical elements each include a hologram interposed between two electrodes 52 (FIGS. 2 and 3). The holograms are preferably all Bragg (thick or volume) holograms. The Bragg holograms provide high diffraction efficiencies for incident beams with wavelengths close to the theoretical wavelength satisfying the Bragg diffraction condition and within a few degrees of the theoretical angle which also satisfies the Bragg diffraction condition. The Bragg condition is the combination of wavelength and angle that causes the impinging and diffraction light of the holographic optical element to be in phase with each other. FIG. 5 is a diagram illustrating the Bragg condition, which is well known by those skilled in the art.

In certain circumstances, it may be possible to increase the effective angular bandwidths of the holographic diffraction elements (i.e., the range of incidence angles around that which satisfies the Bragg condition) by designing the relevant holograms so that they have curved phase functions. In a preferred embodiment, the elements for both holographic optical devices are Bragg holograms. In an alternative embodiment, the elements of the second optical device may be Raman-Nath (thin) holograms. Raman-Nath holograms are thinner and require less voltage to switch light between various modes of the hologram than the Bragg holograms, however, Raman-Nath holograms are not as efficient as Bragg holograms. The first optical element may also be a thin hologram.

The hologram is used to control transmitted light beams based on the principles of diffraction. The hologram selectively directs an incoming light beam from the light source 42 either towards or away from a viewer and selectively diffracts light at certain wavelengths into different modes in response to a voltage applied to the electrodes 52. Light passing through the hologram in the same direction as the light is received from the light source 42 is referred to as the zeroth (0th) order mode 44 (FIG. 2). When no voltage is applied to the electrodes 52, liquid crystal droplets within the holographic optical element are oriented such that the hologram is present in the element and light is diffracted from the zeroth order mode to a first (1st) order mode 46 of the hologram. When a voltage is applied to the holographic optical element the liquid crystal molecules within the droplets become realigned, changing the effective refractive index and effectively erasing the hologram, and the incoming light passes through the holographic optical element in the zeroth order mode 44. It is to be understood that the holographic optical elements may also be reflective rather than transmissive as shown in FIG. 2 and described above. In the case of a reflective holographic device, the arrangement of the holographic device and display 12 would be modified to utilize reflective properties of the hologram rather than the transmissive properties shown in FIG. 2.

The light that passes through the hologram is diffracted by interference fringes recorded in the hologram to form an image. Depending on the recording, the hologram is able to perform various optical functions which are associated with traditional optical elements, such as lenses and prisms, as well as more sophisticated optical operations. The hologram may be configured to perform operations such as deflection, focusing, or color filtering of the light, for example.

The holograms are preferably recorded on a photopolymer/liquid crystal composite material (emulsion) such as a holographic photopolymeric film which has been combined with liquid crystal, for example. The presence of the liquid crystal allows the hologram to exhibit optical characteristics which are dependent on an applied electrical field. The photopolymeric film may be composed of a polymerizable monomer having dipentaerythritol hydroxypentacrylate, as described in PCT Publication, Application Serial No. PCT/US97/12577, by Sutherland et al. The liquid crystal may be suffused into the pores of the photopolymeric film and may include a surfactant. The substrate embodying the hologram may be composed of glass, plastics, or a composite material which may be flexible or rigid. The material may also be flat or curved.

The diffractive properties of the holographic optical elements 14r, 14g, 14b, 16r, 16g, 16b depend primarily on the recorded holographic fringes in the photopolymeric film. The interference fringes may be created by applying beams of light to the photopolymeric film. Alternatively, the interference fringes may be artificially created by using highly accurate laser writing devices or other replication techniques, as is well known by those skilled in the art. The holographic fringes may be recorded in the photopolymeric film either prior to or after the photopolymeric film is combined with the liquid crystal. In the preferred embodiment, the photopolymeric material is combined with the liquid crystal prior to the recording. In this preferred embodiment, the liquid crystal and the polymer material are pre-mixed and the phase separation takes place during the recording of the hologram, such that the holographic fringes become populated with a high concentration of liquid crystal droplets. This process can be regarded as a “dry” process, which is advantageous in terms of mass production of the switchable holographic optical elements.

The electrodes (electrode layers) 52 are positioned on opposite sides of the emulsion and are preferably transparent so that they do not interfere with light passing through the hologram. The electrodes 52 may be formed from a vapor deposition of Indium Tin Oxide (ITO) which typically has a transmission efficiency of greater than 80%, or any other suitable substantially transparent conducting material. The electrodes may also be provided with an anti-reflection coating. The transmission of the ITP can be improved to greater than 95% with suitable AR coatings. The electrodes 52 are connected to an electric circuit 58 operable to apply a voltage to the electrodes, to generate an electric field (FIG. 3). Initially, with no voltage applied to the electrodes 52, the hologram is in the diffractive (active) state and the holographic optical element 14r, 14g, 14b, 16r, 16g, 16b diffracts propagating light in a predefined manner. When an electrical field is generated in the hologram by applying a voltage to the electrodes 52 of the holographic optical element the operating state of the hologram switches from the active state to the passive state and the holographic optical element does not optically alter the propagating light. It is to be understood that the electrodes may be different than described herein. For example, a plurality of smaller electrodes may be used rather than two large electrodes which substantially cover surfaces of the holograms. Switching circuitry for the electrodes may also be deposited on the substrate.

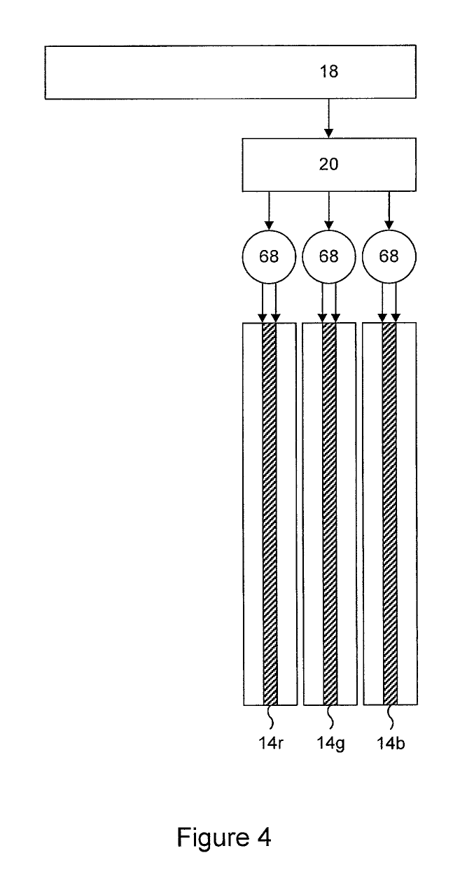

Each holographic optical element 14r, 14g, 14b, 16r, 16g, 16b is holographically configured such that only a particular monochromatic light is diffracted by the hologram. The red optical elements 14r, 16r each have a hologram which is optimized to diffract red light, the green optical elements 14g, 16g each have a hologram which is optimized to diffract green light, and the blue optical elements 14b, 16b each have a hologram which is optimized to diffract blue light. The main controller 18 drives switching circuitry 58 associated with the electrodes 52 on each of the optical elements 14r, 14g, 14b, 16r, 16g, 16b to apply a voltage to the electrodes (FIGS. 3 and 4). The electrodes 52 are individually coupled to the device controller 20, 22 through a voltage controller 68 which selectively provides an excitation signal to the electrodes 52 of a selected holographic optical element switching the hologram to the passive state. The voltage controller 68 also determines the specific voltage level to be applied to each electrode 52. A voltage may also be applied across the hologram such that the holographic optical element is in a partially active state in which light passing through the hologram is partially affected by the optical characteristics of the hologram.

Preferably, only one pair of electrodes 52 associated with one of the three holographic optical elements 14r, 14g, 14b or 16r, 16g, 16b is energized at one time. In order to display a color image, the driver circuit 26 operates to sequentially display three monochromatic images of the color input image. The electrodes 52 attached to each of the holograms are sequentially enabled such that a selected amount of red, green, and blue light is directed towards the viewer. For example, when a red monochromatic image is projected, the controller 18 switches the green and blue holograms 14g, 16g, 14b, 16b to the passive state by applying voltages to their respective electrodes 52. The supplied voltages to the electrodes 52 of the green and blue holograms 14g, 16g, 14b, 16b create a potential difference between the electrodes, thereby generating an electrical field within the green and blue holograms. The presence of the electrical field switches the optical characteristics of the holograms 14g, 16g, 14b, 16b to the passive state. With the green and blue holograms 14g, 16g, 14b, 16b in the passive state and the red holograms 14r, 16r in the diffractive state, only the red holograms optically diffract the projected red image. Thus, only the portion of the visible light spectrum corresponding to red light is diffracted to the viewer. The green holograms 14g, 16g are next changed to the diffractive state by deenergizing the corresponding electrodes 52 and the electrodes of the red holograms 14r, 16r are energized to change the red holograms to the passive state so that only green light is diffracted. The blue holograms 14b, 16b are then changed to the diffractive state by deenergizing their electrodes 52 and the electrodes of the green holograms 14g, 16g are energized to change the green hologram to its passive state so that only blue light is diffracted.

The driver controllers 20, 22 are programmed such that when any one of the three elements 14r, 14g, 14b or 16r, 16g, 16b is activated, the other two elements are deactivated. The main controller 18 is configured to synchronize operation of the two driver controllers 20, 22 so that the red element 14r of the first device 14 is activated whenever the red element 16r of the second device 16 is activated. Similarly, the green elements 14g, 16g are activated together to transmit green light to the viewer and the blue elements 14b, 16b are activated together to transmit blue light to the viewer.

The holographic optical elements 14r, 14g, 14b, 16r, 16g, 16b are sequentially enabled with a refresh rate (e.g., less than 150 microseconds) which is faster than the response time of a human eye so that a color image will be created in the viewer's eye due to the integration of the red, green, and blue monochrome images created from each of the red, green, and blue holograms. Consequently, the final viewable image will appear to be displayed as a composite color. The red, green, and blue holographic elements 14r, 14g, 14b, 16r, 16g, 16b may be cycled on and off in any order.

The following describes operation of the system 10 during display of a blue image by the display device 12. When the holographic diffraction element 14b receives light from the display surface via relay optics 30, the geometry of the system is arranged such that the light is incident upon the element at an angle over a range of angles that satisfy the Bragg diffraction condition for the wavelength band over which the element operates, as indicated by arrow A. As a result, light in the blue wavelength band is diffractively reflected by element 14b towards the second optical device 16, as indicated by arrow B. This light is then diffractively reflected by the holographic diffraction element 1 6b back towards the first device 14, as indicated by arrow C. Due to the geometry of the system, when this light impinges upon the holographic diffraction element 14b, it is incident at an angle or over a range of angles that do not satisfy the Bragg diffraction condition of the wavelength band over which that element operates. Thus, the light passes through the device 14 undeflected and on towards the observer's eye O, as indicated by arrow D.

Since each of the holographic diffraction elements 14r, 14g, 14b, 16r, 16g, 16b is a reflection hologram, it acts essentially as a filter having a relatively narrow bandpass (typically a few tens of nanometers). The bandpass can, however, be increased by constructing each element as a stack of holograms that have different bandpass characteristics. The overall effect of the stack is to produce reflection characteristics which are a combination of those of the individual component holograms. The holograms will be switchable in unison and, since the switching electrodes tend to introduce transmission losses, it is desirable that all of the holograms in a given element are sandwiched between a common pair of electrodes, rather than each hologram being provided with its own electrodes. An alternative way of increasing the bandwidth of a reflection hologram is to use the well known principle of “chirping” where the spacing of the Bragg surfaces increase (or decrease) with depth (i.e., along a direction normal to the surface of the hologram). By controlling the variation in the spacing it is possible to provide a range of bandpass shapes/bandwidths. The bandwidths of a reflection or transmission hologram may also be increased by using liquid crystal and polymer mixtures that provide a larger refractive index modulation.

In order to magnify the image displayed by the display device 12, one or both of the optical devices 14, 16 may be configured to provide optical power magnification by suitably designing the fringes of the respective holographic diffraction elements. Under these circumstances, the relay optics 30 may also perform a pre-magnification function. In an alternative arrangement, the relay optics 30 may provide the sole magnification of the image, with the holographic diffraction elements of the devices 14, 16 being configured as simple plane reflectors. In either arrangement, the relay optics 30 may also be designed to correct aberrations and other geometrical distortions in the image. Elements 14 and 16 may also be designed such that they compensate for a substantial proportion of each others aberrations.

The relay optics may be formed from conventional refractive optical elements, holographic diffractive elements (as described above for the optical devices 14, 16), or a combination thereof. Cylindrical, prismatic, or off-axis aspheric optical components may also be included to correct for geometric aberrations in off-axis optical configurations such as those required to implement wearable displays, as is well known by those skilled in the art. The relay optics 30 may also include reflective optical elements (not shown) to fold the optical path to further reduce the size of the display system 10.

As described above, the display system 10 may be used to view an image displayed by the display device 12. The display system 10 may also be used to view the surroundings by de-activating all of the holographic diffraction elements 14r, 14g, 14b, 16r, 16g, 16b, so that the first and second optical devices allow light from the surroundings to be transmitted to the observer's eye O, as indicated by arrow E. For this mode of operation, the shutter 40 is preferably disposed optically behind the second optical device 16. The shutter 40 is switchable by the main controller 18 between an active, light obstructing state and an inactive, light transmitting state. When the system 10 is used to view the image displayed by the display device, the main controller 18 switches the shutter into its active state to prevent light from the surroundings from reaching the viewer's eye O. When the system is used to view the surroundings, the controller switches all of the holographic diffraction elements into their inactive states, and switches the shutter 40 into its inactive state. The shutter 40 may be a purely optical device and may be composed of switchable liquid crystals, for example, or may be a mechanical shutter.

The system 10 may also be used to combine the image transmitted from the display device 12 and an image from the surroundings (e.g., as in a head-up display) by deactivating the shutter 40 while the holographic diffraction elements 14r, 14g, 14b, 16r, 16g, 16b are in operation. In this case, the internal imagery is preferably performed using narrow wavelength bands of light, so that the color of the ambient imagery is not significantly degraded.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

What is claimed is:

1. A display system comprising:
a display device operable to display an image;
a first optical device positioned to receive light from said image displayed on the display device and reflect said light; and
a second optical device positioned to receive light reflected by said first optical device and reflect said light back towards said first optical device;
wherein said first optical device comprises at least one holographic diffraction element positioned such that light received from the display device is received at an angle that satisfies the Bragg diffraction condition and is reflected by the first optical device and light received from the second optical device is received at an angle that does not satisfy the Bragg diffraction condition and is transmitted through said first optical device.

2. The system of claim 1 further comprising a shutter operable to obstruct light from a user's surroundings when said first and second holographic optical devices are active.

3. The system of claim 2 wherein the shutter is switchable between an active, light obstructing state and an inactive, light transmitting state.

4. The system of claim 3 further comprising a controller operable to control the shutter such that the shutter is in its active position when the holographic diffraction element is in an active state.

5. The system of claim 3 wherein the shutter is operable in its inactive state to transmit an image from the surroundings and wherein the optical devices are operable to transmit an image from the display device to combine the display device image with the image from the surroundings.

6. The system of claim 1 wherein in at least one of said first and second optical devices are configured to magnify said image.

7. The system of claim 1 further comprising relay optics interposed optically between the display device and said first optical device.

8. The system of claim 7 wherein the relay optics comprises at least one magnifying lens.

9. The system of claim 1 wherein the holographic diffraction element is switchable between an active state wherein light from the light source is diffracted by the element and a passive state wherein said light is not substantially diffracted by the device

10. The system of claim 9 wherein the switchable element comprises the hologram interposed between two electrode layers operable to apply an electrical field to the hologram.

11. The system of claim 10 wherein the hologram is formed from a polymer and liquid crystal material.

12. The system of claim 1 wherein said first optical device comprises more than one diffraction element.

13. The system of claim 1 wherein said first and second optical devices each comprises three holographic optical elements.

14. The system of claim 13 wherein the three holographic optical elements each have a hologram recorded therein which is optimized to diffract red, green, or blue light.

15. The system of claim 14 wherein each of the holograms is interposed between two electrode layers operable to apply an electrical field to the hologram to diffract the red, green, or blue light.

16. The system of claim 15 further comprising a controller operable to sequentially supply voltage to and remove voltage from the electrode layers of each holographic optical element to transmit a sequence of monochrome images which are combined to form a color image.

17. The system of claim 1 wherein the display device comprises a liquid crystal display.

18. The system of claim 1 wherein the display device comprises a microdi splay device operable to produce a monochrome image.

19. The system of claim 1 wherein the holographic diffraction element has a Bragg hologram recorded thereon.

20. The system of claim 19 wherein the Bragg hologram is a reflection hologram.
